(19) United States
(12) Patent Application Publication
(10) Pub. No.: US 2024/0199798 A1
(43) Pub. Date: Jun. 20, 2024

(54) DECORATIVE OBJECT MADE FROM PET AND USE OF PET FOR PRODUCING SUCH AN OBJECT

(71) Applicant: BLACHERE ILLUMINATION, Apt (FR)

(72) Inventors: Romain ALLAIN LAUNAY, Apt (FR); Johan HUGUES, Apt (FR); Benjamin DEBAT, Apt (FR); Dorian FABRE, Apt (FR)

(73) Assignee: BLACHERE ILLUMINATION, Apt (FR)

(21) Appl. No.: 18/555,906

(22) PCT Filed: Apr. 22, 2022
(86) PCT No.: PCT/FR2022/000038

§ 371 Date: Oct. 18, 2023

(30) Foreign Application Priority Data
Apr. 19, 2021 (FR) 2104042

(51) Int. Cl. C08G 63/183; C08J 11/06; C08K 3/013

(52) U.S. Cl. CPC C08G 63/183; C08J 11/06; C08K 3/013; C08J 2333/06

(57) ABSTRACT

A decorative object formed by at least one layer of extruded strands, having a thickness of between one and fifteen millimetres of a polymer-based composition advantageously including at least one additive, where the polymer-based composition includes recycled polyethylene terephthalate having at least 99% by mass polyethylene terephthalate and the following residual quantities: no more than 50 ppm of polyvinyl chloride, no more than 100 ppm of water, and no more than 30 ppm of polyethylene.

### TECHNICAL FIELD

The invention relates to a decorative object made from polyethylene terephthalate or mainly based on polyethylene terephthalate, of a particular origin and composition.

The invention relates to the technical field of decorative objects such as temporary or permanent luminous decorations, and in particular to luminous decorations located outdoors, such as those traditionally installed for celebrations and other events, for example in the field of luminous advertising decorations or for promotions in shop windows.

### BACKGROUND

Decorative objects, such as in particular luminous decorations, are normally produced from an aluminium frame on which one or more luminous garlands are secured, generally formed by a succession of LEDs.

In the patent documents FR 2796446 and FR 3069800 in the name of the applicant, this frame supporting garlands is in particular produced by injection-extrusion of plastics material.

Thus such decorative objects, because they must secure or hold lightings in the form of garlands or other decoration elements, require a partial or complete frame made from a mechanically strong material. In general, this material forming a frame for supporting lightings or the like consist of aluminium since this material is light while being strong.

Nevertheless, such decorative objects are complex to produce since they require two distinct steps, a first step of producing the metal frame and a second step of moulding or extruding a plastics material on all or part of the metal frame, to house the lightings and/or to form an original shape.

At the present time decorative objects are known entirely made from plastics material but then these objects are made from extruded strands having a very high thickness or diameter, of the order of at least three centimetres in thickness or in diameter.

The present invention sets out to remedy this gap by proposing a decorative object produced solely from a polymer material selected especially to have excellent mechanical properties and properties of electrical insulation and resistance to heat or to severe environmental conditions (great differences in temperature and humidity). This is because the decorative object must be able to withstand sometimes severe conditions of use and stresses, and therefore have good mechanical, thermal, chemical and environmental properties.

Moreover, one objective of the present invention aims to reduce the negative impact of synthesis materials—plastics materials and other materials including these plastics materials
on our environment.

In the prior art the document US 2015/078000 is known that does not disclose the use of recycled PET or even PET strands having a thickness of between 1 mm (millimetre) and 15 mm and even less the fact that the PET is envisaged for producing decorative objects.

The article entitled “Recycling of PET” is also known, written by Awaja F et al. and appearing in 2005 in the European Polymer Journal, which discloses a strand of recycled PET having a thickness of 0.45 mm. Such a strand was tested by the applicant (cf. results in Table 1 for a strand 0.5 mm thick) and does not under any circumstances have the mechanical properties necessary for a decorative object according to the present invention. It is also noted that this document teaches only for a person skilled in the art to adopt recycled PETs having a quantity of water (MW) of less than 0.02% (cf. paragraph 2.1.2).

### SUMMARY

It was also found by the applicant, after various experiments and manipulations, that a particular recycled polyethylene terephthalate (PET) composition could satisfy all the requirements, mainly, but not exclusively, of a mechanical nature, for obtaining a decorative object.

The solution proposed by the invention is a decorative object formed by at least one layer of extruded strand, having a thickness of between one and fifteen millimetres, of a polymer-based composition advantageously including at least one additive.

The device according to the invention is characterised in that the polymer-based composition consists of recycled polyethylene terephthalate or a mixture of recycled polyethylene terephthalate and of non-recycled polyethylene terephthalate, having at least 99% by mass polyethylene terephthalate and the following residual quantities:
no more than 50 ppm of polyvinyl chloride,
no more than 100 ppm of water, and
no more than 30 ppm of polyethylene, preferably no more than 15 ppm of polyethylene.

The expression “decorative object” means an object that has as its purpose the aesthetic decoration of a place, indoors or outdoors. Naturally, this decorative object may be associated with one or more other visual elements such as for example garlands or lights and, in this case, the decorative object also serves as a support for these elements associated with the decorative object.

The expression “mixture of recycled polyethylene terephthalate (PET) and non-recycled polyethylene terephthalate” means a mixture based on recycled polyethylene terephthalate incorporating or including an addition of non-recycled polyethylene terephthalate, i.e. not resulting from a recycling process, coming from a direct synthesis of polyethylene terephthalate. This non-recycled PET may consist of so-called “virgin” PET or PET-G, glycol-modified polyethylene terephthalate, and this non-recycled PET may have, in whole or in part, virgin PET and/or PET-G. In other words, the non-recycled PET may itself consist of a PET mixture, typically a mixture of PET and PET-G, or consist entirely of PET-G.

The water content is determined by Karl Fischer titration while the PVC (polyvinyl chloride) and PE (polyethylene) content can be obtained by various methods known to a person skilled in the art and which give identical or almost identical results, in particular ASTM D5991-17 (C or D method) of 2017 for PVC and ISO 11542-1 of 2001 or ISO 1133-1 of 2011 for PE.

According to an advantageous embodiment, a mixture of recycled PET and of PET (not recycled) has at least 50% by weight recycled PET, preferentially at least 70% by weight recycled PET.

Apart from the “mechanical” qualities of the decorative object according to the invention, the use of recycled PET makes it possible to recycle some of this plastics material abundantly used at the present time in bottles. Thus it is possible to create a decorative object that is easy to produce, having excellent mechanical properties and virtuous with respect to ecological considerations.

It should be noted that the expression “polymer-based composition” refers here to the use of recycled PET granules conventionally in the form of granules.

Recycled PET conventionally comes from a recycling of bottles in accordance with the following successive steps:
collecting the PET
sorting the PET
grinding into flakes

In reworking factories, an additional sorting is implemented to eliminate the last undesirable elements. These packages are next ground and reduced to the form of flakes.
separation of stoppers and labels

The reworking factories next clean the PET flakes while removing therefrom all the other constituents of the bottle.
a last optical sorting

To improve the quality of the flakes, reworkers sometimes implement a last purification step by optical sorting. For this purpose, use is made of various detection methods and cameras that will locate the last undesirable elements among the PET flakes. A blowing system next separates the PET flakes from the other types of plastics material. There are various PET flake typologies: those of light PET (coming from transparent or light-blue tinted bottles) and those of dark PET (coming from dark-blue, green or coloured bottles).

In the context of the present invention, the recycled PET preferentially comes from flakes of dark PET.
extruding the PET

The PET flakes will then begin an extrusion phase. This consists in melting the flakes at 280° C. in an enormous machine to give rods that will be cooled in water and then cut to form granules. There are clear granules coming from clear PET and coloured granules coming from dark PET.
purification of the granules

The PET granules are next purified by polycondensation.

It is during this last step that various recycled PETs are obtained, with regard to their quality or in other words their residual quantities. It is important to note here that there are substantially as many recycled PET compositions as there are PET recycling methods.

In its objective of producing an economical and technically satisfactory decorative object, the present invention sets out to make a selection first of all on the nature of the polymer selected, and then, once this polymer is selected, to define a selection among all the possibilities and variants of this selected polymer.

The remaining less than 1% by weight of the polymer composition can consist of a polyester such as for example a PLA (polylactic acid polymer) or a PCL (polycaprolactone).

Other advantageous features of the invention are listed below. Each of these features can be considered alone or in combination with the remarkable features defined above. Each of these features contributes, where applicable, to solving specific technical problems defined earlier in the description and in which the remarkable features defined above do not necessarily participate. The latter may be the subject, where applicable, of one or more divisional patent applications:

Preferentially, the residual quantities furthermore have no more than five (5) ppm of metals. The term “metal” here means mainly, but not exclusively, metal hydroxides such as for example a sodium hydroxide, potassium hydroxide or calcium hydroxide. The applicant was able to determine that, beyond a certain quantity of metals, the latter have a negative impact on the mechanical and/or physical and chemical properties of the decorative object manufactured.

Preferentially, the residual quantities furthermore have no more than ten (10) ppm of polyacrylonitrile (PAN). This PAN is a component that is liable to be found in greater or lesser quantity in recycled PETs. However, once again, the applicant has shown a negative impact of this PAN, when present beyond a certain quantity, on the mechanical and/or physical and chemical properties of the object manufactured.

Highly advantageously, the residual quantities are:
no more than 20 ppm of polyvinyl chloride,
no more than 50 ppm of water, preferentially no more than 20 ppm of water.

The applicant has shown that complying with these limits of residual quantity of PVC and of water further improves the mechanical and/or physical and chemical properties of the object manufactured.

According to one possibility offered by the invention, the aforementioned polymer-based composition is mixed with at least one additive to form the extruded strands, said additive being present in the “polymer-based composition—additive” mixture to the extent of no more than 40% by weight of said mixture.

Preferentially, the additive is present in the “polymer-based composition—additive” mixture to the extent of no more than 10% by weight of said mixture, preferably no more than 5% by weight of said mixture.

Advantageously, the additive consists of plasticisers, adhesion promoters, stabilisers/UV absorbers, antioxidants, flame retarders pigments/dyes/whiteners and/or fillers. Here, use of the plural can mean a plurality of one and the same component, for example the expression “plasticisers” may refer to a plurality of plasticisers of one and the same composition and chemical nature/family. This same expression in the plural may also refer to a plurality of different components—from a chemical point of view, the component is not unique—through their composition and their chemical nature/family, all belonging to the same category of additives, for example to the family of plasticising additives.

Preferably, the decorative object has a plurality of layers of extruded strands superimposed or added one on top of each other.

Preferentially, the thickness of the strand or strands is between two and eight millimetres, preferably between three and five millimetres.

Another aspect of the invention relates to a use of a polymer-based composition, advantageously including at least one additive, the polymer-based composition consisting of recycled polyethylene terephthalate having at least 99% by mass polyethylene terephthalate and the following residual quantities:
no more than 50 ppm of polyvinyl chloride, advantageously no more than 10 ppm of polyvinyl chloride,
no more than 100 ppm of water, advantageously no more than 10 ppm of water, and
no more than 30 ppm of polyethylene,
   for manufacturing a decorative object formed from at least one layer of extruded strand, advantageously a plurality of layers of strands, having a thickness of between one and fifteen millimetres.

According to a first embodiment of the invention, the invention is implemented by a method for manufacturing a decorative object from at least a first layer of an extruded strand of a polymer-based composition, including a step of passing a polymer-based composition through an extrusion die from an inlet supplying said composition to an extrusion head, having an opening diameter D, from which an extruded strand of said composition emerges, the temperature of the extruded strand, at the discharge from the extrusion head, being between 160° C. and 260° C., characterised in that the extrusion head is located at a distance H of between two and eight mm from a support for receiving the layer of extruded strand, the extruded strand being deposited on the reception support by the effect of gravity, and in that the opening diameter D of the extrusion head is equal to H +/−1 millimetre.

In this context, advantageously, the distance H is between four and six millimetres, advantageously the distance H is equal to four millimetres.

Advantageously, the extrusion head moves at a speed of between forty and one hundred and fifty millimetres per second, advantageously between sixty and one hundred millimetres per second.

Preferably, the extruded strand emerges from the extrusion head at a rate of between five and fifteen kilos per hour, advantageously between six and ten kilos per hour.

Preferably, the extruded strand has, at the discharge from the extrusion head, a viscosity of between four hundred (400) and four hundred and fifty (450) pascals per second (Pa·s⁻¹) defined in accordance with ISO 11443.

According to a second embodiment of the invention, the invention is implemented by a method for manufacturing a decorative object from at least a first layer of a hot-extruded strand of a polymer-based composition, including a step of passing a polymer-based composition through an extrusion die from an inlet supplying said composition to an extrusion head from which the extruded strand emerges in an ambient environment, the first layer of extruded strand being deposited on a reception support, characterised in that said method comprises the steps of:
using a polymer-based composition consisting of recycled polyethylene terephthalate or a mixture of recycled polyethylene terephthalate and of non-recycled polyethylene terephthalate,
heating the composition so that the temperature of the extruded strand, at the outlet of the extrusion head, is between 200° ° C. and 300° C.,
cooling the reception support so as to force the cooling of the first layer of extruded strand by conduction, the temperature of cooling of said support being lower than or equal to the temperature of the ambient environment.

Advantageously, the cooling temperature of the reception support is selected so that the cooling rate of the first layer of extruded strand is between 250° C./min and 350° C./min.

Preferably, the reception support is produced from a material selected from the following family: aluminium, aluminium alloy, copper and copper alloy.

Advantageously, the reception support is cooled to a temperature of between −10° C. and +10° C.

According to a third embodiment of the invention, the invention is implemented by a method for manufacturing a decorative object from at least one hot-extruded strand of a hot-extruded strand of a polymer-based composition, including a step of passing a polymer-based composition through an extrusion die from an inlet supplying said composition to an extrusion head from which the extruded strand emerges in an ambient environment, a first layer of extruded strand being deposited on a reception support, characterised in that said method comprises the steps of:
using a polymer-based composition consisting of recycled polyethylene terephthalate or a mixture of recycled polyethylene terephthalate and of non-recycled polyethylene terephthalate,
heating the composition so that the temperature of the extruded strand, at the outlet of the extrusion head, is between 200° C. and 300° C.,
blowing a gas onto the extruded strand so as to force the cooling of said strand by convection, said gas being blown at a temperature of less than or equal to the temperature of the ambient environment.

The expression “temperature of the ambient environment” means a temperature of between 15° C. and 30° C. for a pressure of approximately 1 atmosphere (˜105 pascals).

The first, second and third embodiments presented above are advantageously implemented and can optionally be combined from only one of these embodiments (one of the three embodiments) up to three embodiments combined.

According to an aspect relating to the decorative object, the latter can be obtained by a method for manufacturing a decorative object formed by the hot extrusion of at least one strand of a polymer-based composition, including the following steps:
passing a polymer-based composition through an extrusion die from an inlet supplying said composition to a movable extrusion head from which the extruded strand emerges, a first layer of extruded strand being deposited on a reception support,
moving the extrusion head on a predefined extrusion path, so that the decorative object has layers of at least one extruded strand stacked one on top of the other, said layers being parallel to the reception support and defining extrusion levels, characterised in that the extrusion is implemented so that the decorative object comprises at least one first zone having a first number of layers and a second zone having a second number of layers different from said first number.

### Advantageously:

the first number of layers in the first zone is greater than or equal to 1, and
the second number of layers in the second zone is greater than or equal to 3.

Preferably, the manufacturing method comprises a step of equipping the extrusion head with an obturator able to move between an open position enabling the strand to emerge from said head and a closed position preventing the strand from emerging from said head.

Preferably, to extrude a layer of level N in the first zone from a layer of level M in the second zone, such that M is greater than or equal to N+1, the following steps are implemented:
placing the obturator in the closed position after the end of the extrusion of the layer of level M in the second zone,
moving the extrusion head from the second zone to an extrusion position located facing a layer of level N−1 of the first zone, the obturator being maintained in the closed position,
when the extrusion head is positioned in the extrusion position of the first zone, placing the obturator in the open position and extruding the layer of level N by depositing it on the layer of level N−1 of said first zone.

According to an advantageous embodiment, to extrude a layer of level N in the second zone from a layer of level M in said second zone, such that M is greater than or equal to N+2, the following steps are implemented:
placing the obturator in the closed position after the end of the extrusion of the layer of level M,
moving the extrusion head to an extrusion position located facing a layer of level N−1 of said second zone, the obturator being maintained in the closed position,
when the extrusion head is positioned in the extrusion position of the second zone, placing the obturator in the open position and extruding the layer of level N by depositing it on the layer of level N−1 of said second zone.

Advantageously, to extrude a layer of level M in the second zone from a layer of level N in said second zone, such that M is greater than or equal to N+2, the following steps are implemented:
placing the obturator in the closed position after the end of the extrusion of the layer of level N,
moving the extrusion head to an extrusion position located facing a layer of level M−1 of said second zone, the obturator being maintained in the closed position,
when the extrusion head is positioned in the extrusion position of the second zone, placing the obturator in the open position and extruding the layer of level M by depositing it on the layer of level M−1 of said second zone.

Preferably, the manufacturing method comprises a step of securing the extrusion head to a robotic manipulation arm so that said head can be inclined by an angle α of between 0° and 90° with respect to a normal to the reception support.

In this context, advantageously, at least in the second zone, the layers are excluded so as to have adjacent borders and in which, to extrude a layer of level N in the second zone from a layer of level M in said second zone, such that M is greater than or equal to N+2, the following steps are implemented:
after the end of the extrusion of the layer of level M, orienting the extrusion head perpendicularly to the borders,
moving the extrusion head so as to extrude a strand along the borders, from the layer of level M, to reach a position of extruding the layer of level N, said position being located facing a layer of level N−1 of the second zone,
orienting the extrusion head perpendicularly to the layer of level N−1 and extruding the layer of level N by depositing it on said layer of level N−1.

Other advantages and features of the invention will emerge better from the reading of the description of a preferred embodiment that will follow.

### DETAILED DESCRIPTION OF EMBODIMENTS

A decorative object can be formed by extruding a recycled PET composition according to the invention by extrusion techniques well known to a person skilled in the art.

The decorative object can for example consist of a stylised snowflake installed on a volute. By way of example, its length is between 50 centimetres (cm) and two metres while its width is between twenty centimetres and one metre. With regard to its thickness, one particularity of the present invention lies in the fact that such an object is formed by at least one layer of extruded strand, optionally a plurality of layers of extruded strands, and these extruded strands all have a substantially identical thickness, between 3 mm and 10 mm (millimetres). This decorative object can be attached to a cable or secured to a post or a wall for outdoor installation, for example in a street or on the façade of a monument, or inside a dwelling. One or more luminous garlands, not visible on this appended figure, can be secured to this object.

Advantageously, it can also be envisaged for a decorative object according to the invention to be able to be obtained by the following specific techniques.

Thus the extrusion die used here is a conventional extrusion die that is in no way modified in the context of the present invention, except advantageously with regard to the opening diameter D of its extrusion head, which is related to the distance or the height H at which this extrusion head is located or is situated from the surface of the reception support. Naturally, when a multilayer decorative object according to the invention is produced, i.e. by superimposing a plurality of extruded strands placed one on top of the other, it is the surface of the last extruded layer of strands that forms the reception support. Consequently, in this latter case, the distance H is no longer that between the reception support and the extrusion head but the distance or height, still designated H, between the top surface of the extruded strand and the extrusion head.

Considering the extrusion die, the opening diameter D of the extrusion head can be fixed or variable, according to possibilities well known in the technical field, but naturally this opening diameter D generally being constant throughout the duration of extrusion of the strand to form the decorative object. In the case where this opening diameter D is variable or different during the manufacture of the decorative object, the preferred ratio defined in the context of the present invention between the lengths H and D still remains valid. Thus, if D is modified during manufacture of a decorative object according to the invention, then H is modified accordingly.

The means for controlling and moving the extrusion die moreover comprise an electronic management unit, not shown on the accompanying figures. The movements of the robotic arm 30 are controlled by this electronic management unit. The management unit is in particular in the form of a portable or fixed computer, provided in particular with a processor, microprocessor or CPU (standing for central processing unit) and a memory, in which software is recorded the instructions of which, when they are executed by the processor, microprocessor or CPU, control the movement of the extrusion head in space. This electronic management unit also manages the extrusion die, i.e. in particular the supply with polymer-based composition and the extrusion rate.

The term “software” can be understood as: computer application, computer programs or software. For reasons of clarity, it must be understood, within the meaning of the invention, that “the robotic arm does something” means “the software executed by the processor, microprocessor or CPU of the electronic management unit does something”.

The movement of the extrusion die on a predefined path makes it possible to manufacture a decorative object by depositing material, for a single-layer decorative object, or by adding material (additive manufacturing) by stacking in layers of extruded strands. These layers of extruded strands can be stacked on top of each other and/or optionally alongside each other. Stacking the layers of extruded strands creates the volume of the decorative object even if such an object having a single-layer strand already has a thickness of at least several millimetres. The path of the extrusion die along the longitudinal, axial and optionally vertical axes, i.e. in three directions perpendicular to each other, makes it possible to produce all types of contours and curves of the decorative object required.

In practice, a designer draws the required decorative object by means of a computer aided design (CAD) tool. The file obtained is processed by the software recorded in the memory of the electronic management unit, which organises the cutting of the various layers into slices necessary for producing the decorative object. The robotic arm is controlled according to this cutting into slices, so that the extrusion die deposits the strand layer by layer, if required, until the final decorative object is obtained. The decorative object is thus obtained quickly and precisely and with optimum repeatability.

Tests and trials that enabled the applicant to evaluate and select the polymer-based composition according to the invention are presented hereinafter. For reasons of clarity, only some of these tests and trials performed by the applicant are presented below.

### Tests Performed on Test Pieces:

Having regard to the use of the decorative object, the mechanical tests were decisive for assessing the plastics materials, and some of the results of the tests and trials performed by the applicant are presented in the table below. Nevertheless, it must be noted that supplementary tests, for example on resistance to ageing—implemented according to the ISO 22088 series of international standards showed results that were particularly interesting for the polymer-based compositions according to the invention.

Identical test pieces, obtained after extrusion, were formed to be able to perform the following standardised tests, i.e. in accordance with ISO 527-1 for determining the Young's modulus and the elongation at break and in accordance with ISO179-1 for Charpy notched impact. Results of tests are presented in table 1 below. With the exception of the PET test piece having a diameter of 0.5 mm, all the other test pieces presented in Table 1 below were tested with an identical diameter, between 4 mm and 9 mm (the other diameters in the range according to the invention, namely 1-15 mm, were of course tested to determine said range).

TABLE 1

| | Young's modulus | Elongation at break | | Notched Charpy impact |
|---|---|---|---|---|
| test piece | (MPa) | (%) | | (kJ · m⁻²) |
| PET (pure) plastics | 1830 (±150) | 45 | (±5) | 1.8 (±0.3) |
| material | | | | |
| Ø = 0.5 mm | | | | |
| ABS plastics | 1600 (±110) | 20 | (±5) | 1.9 (±0.3) |
| material | | | | |
| PC plastics | 2300 (±190) | 120 | (±10) | 2.5 (±0.5) |
| material | | | | |
| PA66 plastics | 1950 (±200) | 45 | (±5) | 2.1 (±0.5) |
| material | | | | |
| PMMA plastics | 80 | 3.5 | (±0.4) | 1.8 (±0.3) |
| material | | | | |
| PET 95% pure + PE | no significant | no significant mechanical | | no significant |
| between 2-5% | mechanical strength | strength following | | mechanical strength |
| | following extrusion | extrusion | | following extrusion |
| PET 99% pure +: | 1920 (±150) | 50 | (±10) | 1.8 (±0.3) |
| PVC > 150 ppm | | | | |
| H₂O > 80 ppm | | | | |
| PE > 45 ppm | | | | |
| PET 99% pure +: | 1950 (±150) | 70 | (±15) | 2.2 (±0.4) |
| PVC~80 ppm | | | | |
| H₂O~110 ppm | | | | |
| PE~40 ppm | | | | |
| PET 99% pure +: | 2000 (±200) | 220 | (±40) | 2.4 (±0.5) |
| PVC~40 ppm | | | | |
| H₂O~40 ppm | | | | |
| PE~10 ppm | | | | |
| PET 99% pure +: | 2100 (±200) | 240 | (±40) | 2.7 (±0.5) |

PVC~20 ppm
H₂O~10 ppm
PE~10 ppm

### In the Table Below, the Following Abbreviations are Used:

ABS: Acrylonitrile butadiene styrene; PC: Polycarbonate; PA66: Polyamide 6-6; PMMA: Polymethyl methacrylate; PVC: Polyvinyl chloride; PE: Polyethylene; —H₂O: water. MPa means megapascal and kJ·m⁻² means kilojoule per square metre. The sign “Ø” means “diameter”.

The test pieces according to the invention—i.e. precisely those presented in the last two lines of the table below—are noted in table below. As can be seen, the test pieces according to the invention have better, or even much better, mechanical-property and extrusion-processability results than for the test pieces according to the prior art or comparative test pieces. These mechanical properties are those sought for a decorative object, according to conventional use thereof under sometimes rigorous environmental conditions: temperature (very much) below 0° C., very wet or very sunny environment, strength while showing very good resistance to impact and to elongation at break.

Other features and properties are taken into consideration for utility thereof as a decorative object, in particular its ability to be painted or coated with an adhesive layer and the stability of its mechanical properties when the variations in temperature and humidity are great.

Moreover, supplementary tests and trials showed better results when the residual quantities, in the composition based on polyethylene terephthalate, furthermore have no more than 5 ppm of metals and/or no more than 10 ppm of polyacrylonitrile.

In addition to these features particular to the polymer composition according to the invention, it can comprise a certain number of additives or components intended to confer additional particular properties and/or to improve the intrinsic properties of the composition.

Thus, prior to the step of extruding the strands, the polymer-based composition according to the invention can be mixed with at least one additive so as to form a final mixture, having additional property or properties and/or function or functions

Naturally, this additive is merely optionally present because of the excellent intrinsic properties of the polymer-based composition according to the invention. It may be noted however that the polymer-based composition according to the invention has excellent mechanical properties, and thus it may be desired, or even necessary, to improve in particular its fire-resistant properties or its property of resistance to ageing under sun rays.

Plasticisers can be added to the composition in order to facilitate use and to improve the productivity of the polymer-based composition according to the invention. Aromatic or naphthalenic paraffinic mineral oils, which also improve the adhesion of the composition according to the invention, can be cited as examples Phthalates, azelates, adipates and tricresyl phosphate can also be cited as plasticiser.

Adhesion promoters, although not necessary, can advantageously be added in order to improve the adhesion of the composition according to the invention when this must be particularly high. The decorative object obtained according to the invention is intended to be used as such, without being associated with a structure such as an aluminium frame or a frame made from another polymer material. Nevertheless, in the latter case in particular, the use of adhesion promoters is useful, or even necessary, in order to ensure perfect cohesion, bonding or association of the decorative object according to the invention and of a support or other polymer-based element, created independently of said decorative object. The adhesion promoter is a non-polymeric ingredient; it may be organic, crystalline, mineral and more preferentially semi-mineral semi-organic. Among these, mention can be made of organic titanates or silanes, such as for example monoalkyl titanates, trichlorosilanes and trialkoxysilane. Advantageously, trialkoxysilanes containing an epoxy, vinyl and amine group will be used.

When the decorative object is intended to remain outdoors for a long period in sunny regions of the globe, UV (ultraviolet) radiation is liable to cause slight yellowing of the polymer-based composition used so that UV stabilisers and UV absorbers such as benzotriazole, benzophenone and other hindered amines can advantageously be added in order to provide transparency or invariant colouring of the decorative object throughout its service life. These compounds can for example be based on benzophenone or benzotriazole. They can be added in quantities of less than 10% by mass of the total mass of the composition and preferentially from 0.1 to 5%.

Antioxidants can also be added to limit yellowing during manufacture and use of the decorative object, such as phosphor compounds (phosphonites and/or phosphites) and hindered phenolics. These antioxidants can be added in quantities of less than 10% by mass of the total mass of the composition and preferentially from 0.1 to 5%.

Flame-retarding agents can also be added. These agents may be halogenated or non-halogenated, use of the latter being advised, or even obligatory, according to the country. Among the halogenated agents, mention can be made of brominated products such as polybrominated diphenyls or phosphobrominated compounds. Use can also be made as non-halogenated agent of additives based on phosphorus such as phosphates, phosphonates and polyphosphonates, nitrogenous organophosphorus compounds, phosphines and phosphine oxide, antimony oxide, polyphosphate oxide, phosphinate oxide or pyrophosphate oxide, melamine cyanurate, pentaerythritol, zeolites, red phosphorus and mixtures of these agents. Among phosphine and phosphine oxide, mention can be made of triphenylphosphine oxide, triphenylphosphine with melamine phosphate or 1,4-diisobutyl-2,3,4,5,6-tetrahydroxy-1,4-diphosphacyclohexane 1,4-dioxide. Among phosphonates and polyphosphonates, mention can be made of cyclic phosphonate, polysulfonyldiphenylene phenylphosphonate, polysulfonyldiphenylene, phenyl thiophosphonate, sirophosphonate or polyphosphonate with biphenyl bridges. Among nitrogenous organophosphorus compounds, mention can be made of melamine phosphate or pyrophosphate, melamine polyphosphate, triphenylphosphine sulfide and diphosphonic acid. Among phosphates, mention can be made of bisphenol A and derivatives thereof, tribisphenylphosphate or resorcinol bis(diphenylphosphate) The polymer-based composition according to the invention may comprise these agents in proportions ranging from 0.5% to 25% with respect to the total mass of the mixture consisting of polymer-based composition according to the invention—additive(s), in the case of flame-retarding agents.

It is also possible to add pigments, such as for example titanium dioxide, or colouring or whitening compounds in proportions ranging up to a maximum of 10% with respect to the total mass of the mixture consisting of “polymer-based composition—additive(s)”, in the case of pigments/colourants/whiteners.

Fillers, in particular of the mineral type, can also be added to improve the thermomechanical strength of the composition. Non-limitatively, silica, alumina or calcium carbonates or carbon nanotubes or glass fibres can be given as examples. These can be made of modified or non-modified clays that are mixed nanometrically; this makes it possible to obtain a more transparent composition.

For reasons of clarity, the tests performed by the applicant on the composition based on polyethylene terephthalate according to the invention including one or more of the aforementioned additives are not presented here, but it has been assessed by the applicant that such additives improve the mechanical properties of the compositions according to the invention and/or confer thereon novel functions, such as fire-resistant properties, or properties of adhesion to another polymer layer or of stability with respect to UV rays.

According to an advantageous possibility offered by the invention, when the extruded strand based on PET polymer is manufactured, the support receiving this extruded strand advantageously has a temperature equal to ambient temperature or a temperature below ambient temperature. Test results are presented in Table 2 below.

TABLE 2

| reception support | | | Young's modulus | Elongation at break |
|---|---|---|---|---|
| (plate) | Cooling T° | Shrinkage (%) | (MPa) | (%) |
| Stainless steel | 100° (heating) | >2 | 2900 | 12 |
| | 20° C. (ambient) | 2< | 1920 | 100 |
| | 0° C. | 2< | 2300 | 190 |
| | −20° C. | 2< | 1720 | 50 |
| Brass | 100° (heating) | >2 | 2850 | 16 |
| | 20° C. (ambient) | 2< | 2100 | 115 |
| | 0° C. | 2< | 2450 | 190 |
| | −20° C. | 2< | 1870 | 85 |
| Cupronickel | 100° (heating) | >2 | 2850 | 18 |
| | 20° C. (ambient) | 2< | 2200 | 120 |
| | 0° C. | 2< | 1980 | 180 |
| | −20° C. | 2< | 1750 | 75 |
| Aluminium or | 100° (heating) | >2 | 2200 | 10 |
| aluminium alloy | 20° C. (ambient) | 2< | 1750 | 150 |
| | 0° C. | 2< | 2100 | 240 |
| | −20° C. | 2< | 1850 | 80 |
| Copper or copper | 100° (heating) | >2 | 2100 | 20 |
| alloy | 20° C. (ambient) | 2< | 1800 | 140 |
| | 0° C. | 2< | 2050 | 230 |
| | −20° C. | 2< | 1900 | 90 |

Always when an extruded strand based on PET polymer is manufactured, it is advantageous to blow a gas onto the extruded strand so as to force the cooling of said strand by convection, said gas being blown at a temperature of less than or equal to the temperature of the ambient environment.

Always when the polymer-based composition is a PET (polyethylene terephthalate), it is advantageous to blow a gas onto the extruded strand so as to force the cooling of said strand by convection, said gas being blown at a temperature of less than or equal to the temperature of the ambient environment.

The selection of the cooling temperature (i.e. the temperature of the bone gas) was determined after many trials and comparative tests. Some of the results of these trials and tests are presented in the table below. Results for heating (100° C.) of the strand are also presented in this table. Identical test pieces, obtained after extrusion of a composition consisting of 99% pure PET (+20 ppm of PVC, 10 ppm of water, and 10 ppm of PE), were formed to be able to perform the following standardised tests, i.e. in accordance with ISO 527-1 for determining the Young's modulus and the elongation at break. The shrinkage criterion is considered, optionally with a slight structural arrangement, in accordance with ISO 294.

The criterion preferentially sought in the context of the present invention is the elongation at break criterion, which must be sufficiently high to prevent the object being fragile. Another criterion is the shrinkage criterion, which must advantageously be no more than 2%. Results of tests are presented in table 3 below.

TABLE 3

| | Shrinkage (%) | Young's | Elongation at |
|---|---|---|---|
| Cooling T° | (MPa) | modulus | break (%) |
| 100° (heating) | >2 | 2200 | 10 |
| 20° C. (ambient) | 2< | 1750 | 150 |
| 0° C. | 2< | 2100 | 240 |
| −20° C. | 2< | 1850 | 80 |

Although the invention has been described in relation to several particular embodiments, it is obvious that it is in no way limited thereto and that it comprises all the technical equivalents of the means described as well as combinations thereof if these fall within the scope of the invention.

The use of the verbs “have”, “comprise” or “include” and their conjugated forms does not exclude the presence of elements or steps other than those stated in a claim.

In the claims, any reference sign between parentheses should not be interpreted as a limitation of the claim.

1-10. (canceled)

11. A decorative object, comprising: at least one layer of extruded strand, having a thickness of between one and fifteen millimetres, of a polymer-based composition advantageously including at least one additive, wherein
the polymer-based composition consists of recycled polyethylene terephthalate or a mixture of recycled polyethylene terephthalate and of non-recycled polyethylene terephthalate, having at least 99% by mass polyethylene terephthalate and the following residual quantities:
no more than 50 ppm of polyvinyl chloride,
no more than 100 ppm of water, and
no more than 30 ppm of polyethylene.

12. The decorative object according to claim 11, wherein the residual quantities furthermore have no more than five ppm of metals.

13. The decorative object according to claim 11, wherein the residual quantities furthermore have no more than ten ppm of polyacrylonitrile.

14. The decorative object according to claim 11, wherein the residual quantities are:
no more than 20 ppm of polyvinyl chloride, and
no more than 50 ppm of water, preferentially no more than 20 ppm of water.

15. The decorative object according to claim 11, wherein the polymer-based composition is mixed with at least one additive to form the extruded strands, said additive being present in the polymer-based composition—additive mixture to the extent of no more than 40% by weight of said mixture.

16. The decorative object according to claim 15, wherein the additive is present in the polymer-based composition—additive mixture to the extent of no more than 10% by weight of said mixture.

17. The decorative object according to claim 15, wherein the additive consists of plasticisers, adhesion promoters, stabilisers/UV absorbers, antioxidants, flame retarders pigments/dyes/whiteners and/or fillers.

18. The decorative object according to claim 11, wherein the decorative object has a plurality of layers of extruded strands superimposed or added one on top of each other.

19. The decorative object according to claim 11, wherein the thickness of the strand or strands is between two and eight millimetres

20. A method of manufacturing a decorative object, comprising: using a polymer-based composition, including at least one additive, the polymer-based composition consisting of recycled polyethylene terephthalate having at least 99% by mass polyethylene terephthalate and the following residual quantities:
no more than 50 ppm of polyvinyl chloride, advantageously no more than 10 ppm of polyvinyl chloride,
no more than 100 ppm of water, advantageously no more than 10 ppm of water, and
no more than 30 ppm of polyethylene, and
forming the decorative object from at least one layer of extruded strand having a thickness of between one and fifteen millimetres.
